(19) United States
(12) Patent Application Publication
(10) Pub. No.: US 2007/0126970 A1
(43) Pub. Date: Jun. 7, 2007

(54) Bonding apparatus having adjacent hot-heads for liquid crystal display manufacture

(75) Inventor: De-Ching Shie, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/633,199

(22) Filed: Dec. 4, 2006

(30) Foreign Application Priority Data
Dec. 2, 2005 (TW) 94142469

(51) Int. Cl. G02F 1/1345

(52) U.S. Cl. 349/149

(57) ABSTRACT

An exemplary bonding apparatus (24) for a liquid crystal display (2) includes a first hot-head (241) and a second hot-head (242) beside the first hot-head. The bonding apparatus includes the first and second hot-heads integrated together, such that the drive IC and the FPC can be bonded onto the liquid crystal panel in one step. Therefore, the bonding apparatus is efficient, and the cost of fabricating the LCD in mass production is reduced.

### FIELD OF THE INVENTION

The present invention relates to bonding apparatuses used in the manufacture of liquid crystal displays (LCDs), and particularly to a bonding apparatus including two hot-heads side by side.

### GENERAL BACKGROUND

With the ongoing development of semiconductor technology, an integrated circuit (IC) and a flexible printed circuit (FPC) have been applied to various kinds of electronic equipment, including a liquid crystal display (LCD). There are three main conventional technologies for bonding an IC onto a liquid crystal panel of an LCD: chip on glass (COG), tape carrier package (TCP), and chip on film (COF). The FPC is generally bonded onto the liquid crystal panel by a surface mounting technology (SMT).

Referring to FIG. 5, a typical LCD 1 includes a liquid crystal panel 10 having a plurality of wires 104, a drive integrate circuit (IC) 11, and a flexible printed circuit (FPC) 12. The wires 104 are strip-shaped metal layers formed on the liquid crystal panel 10. Each of the wires 104 includes a circuit pad 103, which is formed at the end of the wire 104. The circuit pads 103 of the wires 104 are gathered at a first bonding region 101 and a second bonding region 102, which are defined at one side portion of the liquid crystal panel 10. The drive IC 11 is bonded on the first bonding region 101 of the liquid crystal panel 10, and is electrically connected to the circuit pads 103 of the corresponding wires 104. The FPC 12 is bonded on the second bonding region 102, and is electrically connected to the circuit pads 103 of the corresponding wires 104.

Referring also to FIG. 6, the drive IC 11 includes a plurality of metal bumps 110 formed on a bottom surface thereof. The metal bumps 110 are made from gold or lead, and are electrically connected to the circuit pads 103 of the corresponding wires 104 so as to electrically connect the drive IC 11 and the wires 104. Similarly, the FPC 12 includes a plurality of metal bumps 120 formed on a bottom surface thereof. The metal bumps 120 are electrically connected to the circuit pads 103 of the corresponding wires 104 so as electrically connect the FPC 12 and the wires 104. An anisotropic conductive film (ACF) 13 is used to bond the drive IC 11 and the FPC 12 onto the first and second bonding regions 101, 102 of the liquid crystal panel 10, respectively.

Referring also to FIG. 7, a method of bonding the drive IC 11 and the FPC 12 of the liquid crystal display 1 is shown. The bonding method includes the following two steps.

First, one of the ACFs 13 is coated on the first bonding region 101. The drive IC 11 is placed on the ACF 13 of the first bonding region 101, with the metal bumps 110 of the drive IC 11 respectively corresponding in position to the circuit pads 103 of the wires 104. A first hot-head 14 is provided to press the drive IC 11, so as to bond the drive IC 11 onto the first bonding region 101 of the liquid crystal panel 10.

Second, the other ACF 13 is coated on the second bonding region 102. An edge of the FPC 12 is placed on the ACF 13 of the second bonding region 102, with the metal bumps 120 of the FPC 12 respectively corresponding in position to the circuit pads 103 of the wires 104. A second hot-head 15 is provided to press the FPC 12, so as to bond the FPC 12 onto the second bonding region 102 of the liquid crystal panel 10.

In the above bonding method, the two hot-heads 14, 15 are used to respectively bond the drive IC 11 and the FPC 12, and two pressing steps are correspondingly performed. The need for plural hot-heads 14, 15 and plural pressing steps means that the cost of fabricating the LCD 1 is correspondingly high.

Therefore, a new bonding apparatus that can overcome the above-described problems is desired.

### SUMMARY

In one preferred embodiment, a bonding apparatus for a liquid crystal display (LCD) includes a first hot-head and a second hot-head beside the first hot-head.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a top plan view of an exemplary liquid crystal display made by using a bonding apparatus according to a first embodiment of the present invention, showing certain parts of the liquid crystal display cut away.

FIG. 2 is a side plan view of the bonding apparatus of the first embodiment, showing operation of the bonding apparatus to bond a drive IC and an FPC onto a liquid crystal panel of the liquid crystal display of FIG. 1.

FIG. 3 is a side plan view of a bonding apparatus according to a second embodiment of the present invention.

FIG. 4 is a side plan view of a bonding apparatus according to a third embodiment of the present invention.

FIG. 5 is a top plan view of a conventional liquid crystal liquid crystal display, the liquid crystal display including a liquid crystal panel, the liquid crystal panel including a first bonding region and a second bonding region.

FIG. 6 is an enlarged, abbreviated, cross-sectional view taken along line VI-VI of FIG. 5.

FIG. 7 is side plan view of a conventional bonding apparatus, showing operation of the bonding apparatus to bond a drive IC and an FPC onto a liquid crystal panel of the liquid crystal display of FIG. 5.

### DETAILED DESCRIPTION OF PREFERRED EMBODIMENTS

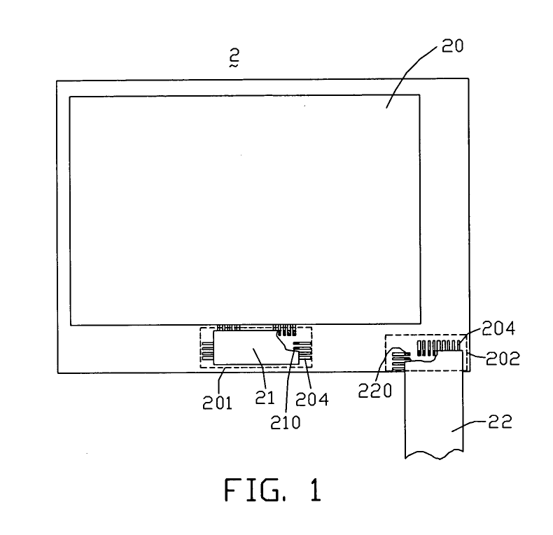

Referring to FIG. 1, an exemplary liquid crystal display (LCD) is shown. The liquid crystal display 2 includes a liquid crystal panel 20 having a plurality of wires (not shown), a drive IC 21, and an FPC 22. Each of the wires includes an elongate circuit pad 204, which is formed at an end of the wire. The circuit pads 204 of the wires are gathered at a first bonding region 201 and a second bonding region 202, which are defined at one side portion of the liquid crystal panel 20. The drive IC 21 is bonded on the first bonding region 201 of the liquid crystal panel 20, and is electrically connected to the circuit pads 204 of the corresponding wires. The FPC 22 is bonded on the second bonding region 202, and is electrically connected to the circuit pads 204 of the corresponding wires. The drive IC 21 includes a plurality of metal bumps 210 formed on a bottom surface thereof. The metal bumps 210 are made from gold or lead, and are electrically connected to the circuit pads 204 so as to electrically connect the drive IC 21 and the corresponding wires. Similarly, the FPC 22 includes a plurality of metal bumps 220 formed on a bottom surface thereof. The metal bumps 220 are electrically connected to the circuit pads 204 so as to electrically connect the FPC 22 and the corresponding wires.

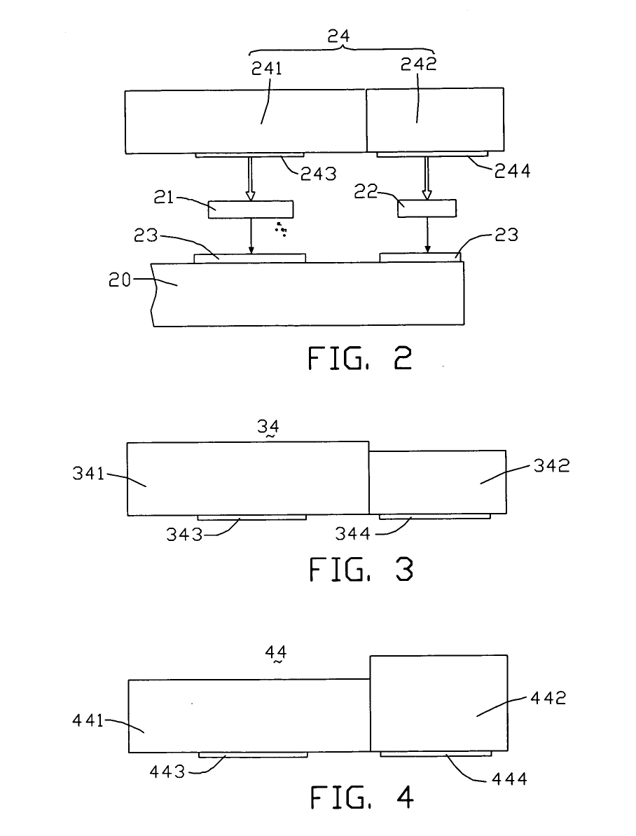

Referring also to FIG. 2, operation of a bonding apparatus according to a first embodiment of the present invention is shown. The bonding apparatus 24 is for bonding the drive IC 21 and the FPC 22 onto the liquid crystal panel 20 of the LCD 2.

An ACF 23 is coated on each of the first and second bonding regions 201, 202. The drive IC 21 and the FPC 22 are respectively placed on the ACF 23 of the first and second bonding regions 201, 202, with the metal bumps 210, 220 thereof respectively corresponding to the circuit pads 204 of the first and second bonding regions 201, 202.

The bonding apparatus 24 includes a first hot-head 241 for pressing the drive IC 21, and a second hot-head 242 for pressing the FPC 22. The first and second hot-heads 241, 242 are integrated together as a single unit, and have a same thickness. The first hot-head 241 includes a first pressing region 243 corresponding to the first bonding region 201. The second hot-head 242 includes a second pressing region 244 corresponding to the second bonding region 202. The first pressing region 243 and the second pressing region 244 are located in a same horizontal plane. A distance between the first and second pressing regions 243, 244 is equal to a distance between the first and second bonding regions 201, 202. Other standard features of the bonding apparatus 24 are as per features known to persons of ordinary skill in the art.

In use of the bonding apparatus 24, parameters of the first and second hot-heads 241, 242, such as pressing heights, bonding temperatures, pressing intensities, and humidity, are respectively adjusted to desired settings within respective predetermined ranges. The bonding apparatus 24 is located above the liquid crystal panel 20, with the first and second hot-heads 241, 242 respectively corresponding in position to the drive IC 21 and the FPC 22.

The bonding apparatus 24 is actuated to press the drive IC 21 and the FPC 22 toward the first and second bonding regions 201, 202. Thus the drive IC 21 and the FPC 22 are tightly bonded onto the first and second bonding regions 201, 202 via the ACF 23, with the metal bumps 210, 220 of the drive IC 21 and the FPC 22 electrically connected to the circuit pads 204 of the first and second bonding regions 201, 202, respectively.

In summary, the bonding apparatus 24 includes the first and second hot-heads 241, 242 integrated together, such that the drive IC 21 and the FPC 22 can be bonded onto the liquid crystal panel 20 in one step. Therefore, the bonding apparatus 24 is efficient, and the cost of fabricating the LCD 2 in mass production is reduced.

Referring to FIG. 3, a bonding apparatus according to a second embodiment of the present invention is shown. The bonding apparatus 34 is similar to the bonding apparatus 24. However, a first hot-head 341 is thicker than a second hot-head 342. A first pressing region 343 of the first hot-head 341 and a second pressing region 344 of the second hot-head 342 are located in a same horizontal plane.

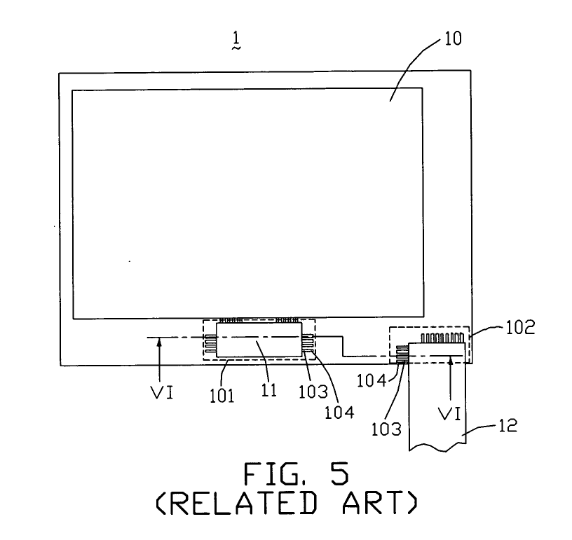

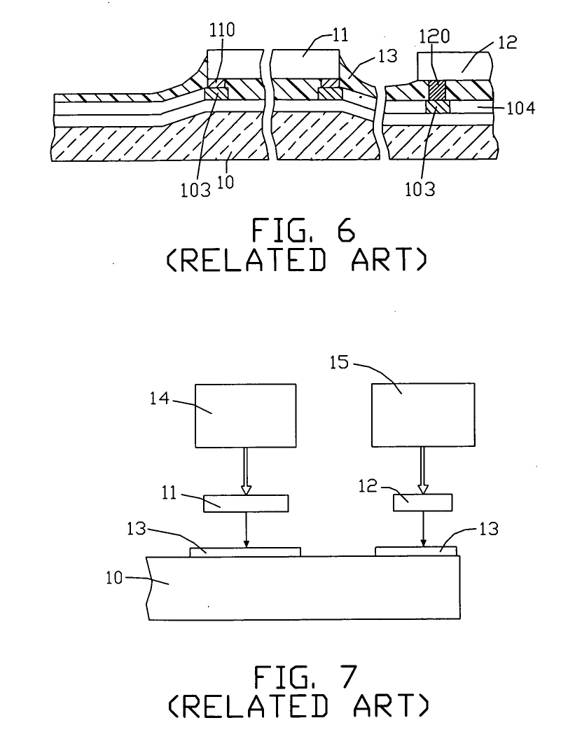

Referring to FIG. 4, a bonding apparatus according to a third embodiment of the present invention is shown. The bonding apparatus 44 is similar to the bonding apparatus 34. However, a first hot-head 441 is thinner than a second hot-head 442. A first pressing region 443 of the first hot-head 441 and a second pressing region 444 of the second hot-head 442 are located in a same horizontal plane.

Further or alternative embodiments may include the following. The first and second hot-heads can have a same thickness, but with first and second pressing regions of the first and second hot-heads being located in different horizontal planes. The first and second hot-heads can be adjacent each other without being integrated together as a single unit, or can adjoin each other without necessarily being integrated together as a single unit.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A bonding apparatus for a liquid crystal display (LCD), comprising:
a first hot-head; and
a second hot-head beside the first hot-head.

2. The bonding apparatus as claimed in claim 1, wherein the first hot-head is configured for bonding a drive integrated circuit onto a liquid crystal panel of the liquid crystal display, and the second hot-head is configured for bonding a flexible printed circuit onto the liquid crystal panel of the liquid crystal display.

3. The bonding apparatus as claimed in claim 2, wherein the first hot-head comprises a first pressing region, and the second hot-head comprises a second pressing region.

4. The bonding apparatus as claimed in claim 3, wherein the first and second hot-heads have a same thickness.

5. The bonding apparatus as claimed in claim 4, wherein the first and second pressing regions are located in a same horizontal plane.

6. The bonding apparatus as claimed in claim 4, wherein the first and second pressing regions are located in different horizontal planes.

7. The bonding apparatus as claimed in claim 3, wherein the first and second hot-heads have different thicknesses.

8. The bonding apparatus as claimed in claim 7, wherein the first and second pressing regions are located in a same horizontal plane.

9. The bonding apparatus as claimed in claim 7, wherein the first and second pressing regions are located in different horizontal planes.

10. The bonding apparatus as claimed in claim 1, wherein the first hot-head and the second hot-head are integrated together as a single unit.

11. A bonding apparatus for a liquid crystal display (LCD), comprising:
a first bonding member for bonding a drive integrated circuit onto a liquid crystal panel of the liquid crystal display; and
a second bonding member for bonding a flexible printed circuit onto the liquid crystal panel of the liquid crystal display;
wherein the first and second bonding members are integrated together as a single unit.

12. The bonding apparatus as claimed in claim 11, wherein the first and second bonding members are hot-heads.

13. A bonding method of making a liquid crystal display, comprising steps of:
providing a liquid crystal panel with spaced first and second bonding regions;
providing an integrally formed first and second hot heads at a same bottom level; and
bonding both drive IC and FPC respectively unto the first and second bonding regions by one common movement of said integrally formed first and second hot heads to have said first and second hot heads respectively press against the drive IC and the FPC.
